(19) United States
(12) Patent Application Publication
(10) Pub. No.: US 2026/0367720 A1
(43) Pub. Date: Nov. 19, 2026

(54) APPARATUS FOR IMPROVING PRESSURE DETECTION PRECISION OF CAPACITIVE PRESSURE-SENSITIVE TOUCHPAD

(71) Applicant: ShenZhen Betterlife Electronic Science And Technology Co.,Ltd, Shenzhen (CN)

(72) Inventors: YUWEN WU, Shenzhen (CN); CHI ZHANG, Shenzhen (CN); MING SUN, Shenzhen (CN); KEHUA XIE, Yangjiang (CN); XIAOYUN ZHANG, Shenzhen (CN)

(21) Appl. No.: 19/728,724

(22) Filed: Jul. 2, 2026

(30) Foreign Application Priority Data
Sep. 23, 2025 (CN) 202511360603.7

(51) Int. Cl. G06F 3/038; G06F 3/0354

(52) U.S. Cl. CPC G06F 3/038; G06F 3/03547

(57) ABSTRACT

An apparatus for improving pressure detection precision of a capacitive pressure-sensitive touchpad, relating to the field of input device technology, includes a capacitive pressure sensor, a touch chip, a DC-DC boost circuit, and a TX signal amplitude amplification circuit; touch chip is connected to DC-DC boost circuit and TX signal amplitude amplification circuit; DC-DC boost circuit is connected to TX signal amplitude amplification circuit; TX pad soldered to pad ring is arranged on the back of pressure-sensitive touchpad; TX signal amplitude amplification circuit connects TX pad with pad ring; RX pad is arranged on the back of pressure-sensitive touchpad and is connected to touch chip. By DC-DC boost circuit, TX signal amplitude amplification circuit, and capacitive pressure sensor that can increase the capacitance variation, the sensitivity, consistency, and linearity in pressure detection on capacitive pressure-sensitive touchpad are greatly improved. The apparatus has both pressure detection and touch detection functions.

### CROSS-REFERENCE TO RELATED APPLICATIONS

This application claims priority to Chinese Patent Application No. 202511360603.7, filed on Sep. 23, 2025, which is hereby incorporated by reference in its entirety.

### TECHNICAL FIELD

The present invention relates to the technical field of input devices, and particularly relates to an apparatus for improving pressure detection precision of a capacitive pressure-sensitive touchpad.

### BACKGROUND

In current technical application of laptop touchpads with pressure-sensitive function, common pressure detection can be carried out in a resistive, inductive, or capacitive way. The three pressure detection ways are different in principles and are also different in pressure signal amplification, sampling, and detection. Resistive pressure detection chips need to support Wheatstone bridge circuits, differential input, multi-stage pre-processing signal amplification, and high-precision ADCs (Analog-to-Digital Converter) (over 16 bits). Pressure-sensitive pressure detection chips need to be able to output PWM (Pulse Width Modulation) signals with a certain drive capability as well as conventional ADCs (12 bits). Capacitive pressure detection is performed based on a parallel-plate capacitance principle, and is to transform the deformation caused when the touchpad is pressed into changes in capacitance, and then to infer the magnitude of the pressure by detecting the changes in capacitance.

Requirements for pressure sensors: in terms of piezoresistive type, strain gauges or piezoresistive sensors can be used. In terms of pressure-sensitive type, detection coils can be directly designed on a PCB (Printed Circuit Board), and specialized sensor devices are not needed. In terms of capacitive type, dome-shaped sensors designed from stainless steel materials can be used. Although piezoresistive pressure detection has high accuracy, it is costly and structurally complex. Although inductive pressure detection is low in cost but has very high structural requirements, complex calibration, and poor consistency.

In capacitive pressure detection, the lowest cost is achieved, the structure is simple, few positions are needed to be calibrated, and most importantly, the capacitive pressure detection does not any additional chip, it only needs to connect a capacitive pressure sensor to a capacitance detection channel of a touch chip on the touchpad, and then the changes in the parallel-plate capacitance generated between the pressure dome-shaped sensor and the PCB can be detected.

However, existing capacitive pressure sensors are of stainless steel dome structures, and the distance from a dome to the PCB is generally 0.1-0.15 mm. A deformable surface and a fixed surface of the dome structure are connected in a closed manner, and its deformation stroke is very small, so that the change in capacitance is extremely small, resulting in problems of low capacitance detection precision, poor consistency, and poor linearity, and it is the main reason of few mass production of touchpads subjected to capacitive pressure detection at present.

Therefore, it needs a novel capacitive pressure-sensitive touchpad system solution to improve the capacitance detection precision of the pressure sensor of the dome structure and solve the problems of consistency and linearity.

### SUMMARY

An objective of the present invention is to provide an apparatus for improving pressure detection precision of a capacitive pressure-sensitive touchpad, and to improve the capacitance detection precision of existing pressure sensors and solve the technical problems of poor consistency and linearity. Many technical effects that can be achieved by the preferred technical solutions among many technical solutions provided by the present invention are described in detail below.

In order to achieve the above objective, the present invention provides the following technical solutions:

the apparatus for improving the pressure detection precision of the capacitive pressure-sensitive touchpad in the present invention includes a capacitive pressure sensor, a touch chip, a DC-DC (Direct Current to Direct Current) boost circuit, and a TX (Transmit) signal amplitude amplification circuit, in which, the touch chip and the DC-DC boost circuit are both connected to the TX signal amplitude amplification circuit, the touch chip is connected to both the DC-DC boost circuit and the TX signal amplitude amplification circuit, and the DC-DC boost circuit is connected to the TX signal amplitude amplification circuit; a TX pad soldered to a pad ring is arranged on the back of the pressure-sensitive touchpad, and the TX signal amplitude amplification circuit connects the TX pad with the pad ring; and an RX (Receive) pad is arranged on the back of the pressure-sensitive touchpad and is connected to the touch chip.

In some embodiments, the DC-DC boost circuit raises a supplied input voltage to a set value and then outputs to the TX signal amplitude amplification circuit, and the DC-DC boost circuit includes a boost converter U1, a first resistor R1, a second resistor R2, a first capacitor C1, a second capacitor C2, a third capacitor C3, and an inductor L; a pin 6 of the boost converter U1 is supplied with the input voltage; a pin 2 is connected to the pin 6 and a pin 4 through the inductor L; the pin 2, the pin 4, and the pin 6 are grounded through the first capacitor C1; a pin 5 of the boost converter U1 is connected between the first resistor R1 and the second resistor R2, in which, the first resistor R1 and the second resistor R2 are connected in series; one end of the first resistor R1 is connected to a pin 3 of the boost converter U1, and one end of the second resistor R2 is grounded; one plate of the second capacitor C2 is connected between the first resistor R1 and the second resistor R2, in which, the first resistor R1 and the second resistor R2 are connected in series, and the other plate is connected to the pin 3 of the boost converter U1; one plate of the third capacitor C3 is connected to the pin 3 of the boost converter U1, and the other plate is grounded; and the pin 3 of the boost converter U1 is an output terminal for boosting voltage of the DC-DC boost circuit.

In some embodiments, the TX signal amplitude amplification circuit amplifies the voltage amplitude of the inputted TX signal to a preset amplitude and then outputs to the TX pad, and the TX signal amplitude amplification circuit includes a comparator U2, a third resistor R3, a fourth resistor R4, a fifth resistor R5, a sixth resistor R6, a seventh resistor R7, an eighth resistor R8, and a fourth capacitor C4.

The pin 1 and a pin 7 of the comparator U2 are two output terminals of the TX signal amplitude amplification circuit; the pin 1 is pulled up to 15V through the third resistor R3, and the pin 7 is pulled up to 15V through the sixth resistor R6; the pin 2 of the comparator U2 is connected to a reference voltage VDD (Voltage Drain-Drain) through the fourth resistor R4; and the pin 6 of the comparator U2 is connected to the reference voltage VDD through the seventh resistor R7; the pin 3 and the pin 5 of the comparator U2 are connected to an inputted TX signal through the fifth resistor R5 and the eighth resistor R8, respectively; a pin 8 of the comparator U2 is connected to the output terminal of the DC-DC boost circuit and grounded through the fourth capacitor C4; the TX signal is a 5V square wave signal; and the reference voltage VDD is a 3.3V voltage signal.

In some embodiments, the frequency of the TX signal sent by the touch chip to the TX signal amplitude amplification circuit is 100 KHz-200 KHz, and the frequency of the TX signal amplified by the TX signal amplitude amplification circuit is 100 KHz-200 KHz.

In some embodiments, once the pad ring of the capacitive pressure sensor is connected to the TX signal amplitude amplification circuit, it also enhances electrostatic protection through a TVS (Transient Voltage Suppressor) diode D.

In some embodiments, the apparatus for improving the pressure detection precision of the capacitive pressure-sensitive touchpad further includes a main control chip which is connected to the touch chip and the DC-DC boost circuit.

In some embodiments, the apparatus for improving the pressure detection precision of the capacitive pressure-sensitive touchpad further includes a motor driver chip and a linear motor connected to the motor driver chip, and the motor driver chip is connected to the touch chip and the main control chip.

In some embodiments, the capacitive pressure sensor includes the pad ring arranged on the periphery, a metal dome arranged in the pad ring, and a connecting part arranged between the pad ring and the metal dome; the metal dome is lifted by the connecting part from the plane of the pad ring to form a stroke with a preset height; the connecting part includes hollow structures and connecting ribs, and the hollow structures and the connecting ribs are arranged at intervals in sequence; the connecting ribs form a deformable structure with the metal dome, and the pad ring, the metal dome, and the connecting ribs form a conductor; if the pad ring is soldered onto the TX pad of the pressure-sensitive touchpad, the metal dome and the corresponding RX pad on the pressure-sensitive touchpad form a parallel-plate capacitance; the pad ring and the RX pad form a fixed plate; and the metal dome serves as a deformable plate.

In some embodiments, if the pad ring is soldered onto the TX pad of the pressure-sensitive touchpad, the RX pad which forms the parallel-plate capacitance with the metal dome on the pressure-sensitive touchpad is coated with solder mask.

In some embodiments, a pressure surface of the metal dome is provided with a soft silicone indenter.

One of the above technical solutions in the present invention has the following advantages or beneficial effects:

according to the present invention, the DC-DC boost circuit and the TX signal amplitude amplification circuit are utilized to raise a TX drive voltage in normal voltage processes of the touch chip to be above 15V, and up to 20 V; and the high-amplitude drive voltage can be utilized to detect slight pressure deformation on the capacitive pressure-sensitive touchpad. Moreover, the capacitive pressure sensor that can significantly increase the capacitance variation is arranged, thereby greatly improving the sensitivity, consistency, and linearity in pressure detection on the capacitive pressure-sensitive touchpad, and effectively overcoming the shortcomings in existing capacitive pressure detection. Furthermore, besides the pressure detection function, the apparatus for improving the pressure detection precision of the capacitive pressure-sensitive touchpad in the present invention has a touch detection function.

### BRIEF DESCRIPTION OF THE DRAWINGS

In order to more clearly illustrate the technical solutions of the embodiments of the present invention, the accompanying drawings required for the description of the embodiments will be briefly introduced below; obviously, the accompanying drawings described below are only some embodiments of the present invention. For those skilled in the art, other accompanying drawings can be obtained based on these accompanying drawings without any inventive effort; in the accompanying drawings:

FIG. 1 is a schematic structural diagram of a capacitive pressure sensor according to an embodiment of the present invention;

FIG. 2 is a schematic diagram of a cross-section A-A of a capacitive pressure sensor according to an embodiment of the present invention;

FIG. 3 is a schematic diagram of dimensions of a capacitive pressure sensor according to an embodiment of the present invention;

FIG. 4 is a front view, a side view, and a back view of a capacitive pressure sensor for comparison according to an embodiment of the present invention;

FIG. 5 is a structural diagram of an apparatus for improving pressure detection precision of a capacitive pressure-sensitive touchpad according to an embodiment of the present invention;

FIG. 6 is a schematic structural diagram of a circuit of a mutual-capacitance touch chip according to an embodiment of the present invention;

FIG. 7 is a schematic structural diagram of a DC-DC boost circuit according to an embodiment of the present invention;

FIG. 8 is a schematic structural diagram of a TX signal amplitude amplification circuit according to an embodiment of the present invention;

FIG. 9 is an exploded view of a capacitive pressure-sensitive touchpad provided with four capacitive pressure sensors according to an embodiment of the present invention;

FIG. 10 is a schematic diagram of drive and sensing interfaces of four capacitive pressure sensors of a capacitive pressure-sensitive touchpad according to an embodiment of the present invention; and

FIG. 11 is a schematic structural diagram of a touch chip according to an embodiment of the present invention.

In the figures:

1, pad ring; 2, metal dome; 3, connecting part; 31, hollow structure; 32, connecting rib; 4, pressure-sensitive touchpad; 41, front surface of pressure-sensitive touchpad; 5, soft silicone indenter; 51, back shell contact surface; 6, RX pad; 7, TX pad; 8, solder mask; and 9, solder paste.

### DESCRIPTION OF EMBODIMENTS

In order to make the objectives, technical solutions, and advantages of the present invention clearer, various exemplary embodiments to be described below will refer to the corresponding accompanying drawings. These accompanying drawings constitute a part of the exemplary embodiments, in which various exemplary embodiments that can be used for implementing the present invention are described. Unless otherwise indicated, the same numerals in different drawings represent the same or similar elements. The embodiments described in the following exemplary embodiments do not represent all the embodiments consistent with the disclosed. It is to be understood that they are merely examples of processes, methods, and apparatus consistent with some aspects of the present invention as detailed in the appended claims. Other embodiments may be used, or structural and functional modifications may be made to the embodiments listed herein without departing from the scope and essence of the present invention.

In the description of the present invention, the term “plurality” means two or more. The terms “linkage” and “connection” should be understood in a broad sense, for example, they may refer to a fixed connection, a detachable connection, an integral connection, a mechanical connection, an electrical connection, a communication connection, a direct linkage, or an indirect linkage through an intermediate medium, or communication within two elements or the interaction between two elements. For those skilled in the art, the specific meaning of the above terms in the context of the present invention can be understood according to the specific situation.

In order to illustrate the technical solutions of the present invention, specific embodiments are provided below for description, only the parts related to the embodiments of the present invention are shown.

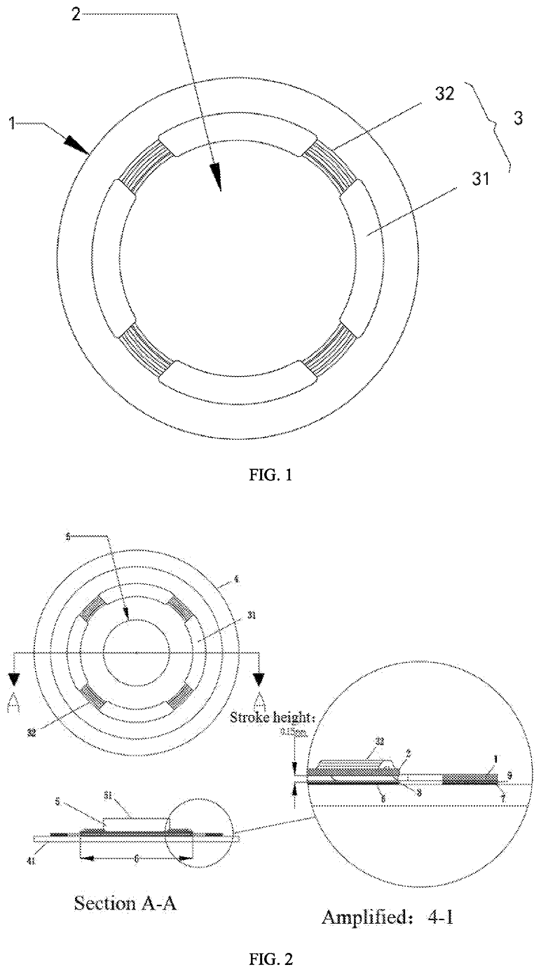

Embodiment 1: As shown in FIG. 1 to FIG. 2, a capacitive pressure sensor in this embodiment includes a pad ring 1 arranged on the periphery, a metal dome 2 arranged in the pad ring 1, and a connecting part 3 arranged between the pad ring 1 and the metal dome 2; and the metal dome 2 is lifted by the connecting part 3 from the plane of the pad ring 1 to form a stroke with a specified height.

In one or more embodiments, the metal dome 2 is lifted by the connecting part 3 from the plane of the pad ring 1 to form a stroke with height of 0.15 mm.

Based on the above embodiments, the connecting part 3 includes hollow structures 31 and connecting ribs 32, and the hollow structures 31 and the connecting ribs 32 are arranged at intervals in sequence; the connecting ribs 32 form a deformable structure with the metal dome 2, and the pad ring 1, the metal dome 2, and the connecting ribs 32 form a conductor. If the pad ring 1 is soldered onto a TX pad 7 of a pressure-sensitive touchpad 4, the metal dome 2 and a corresponding RX pad 6 on the pressure-sensitive touchpad 4 form a parallel-plate capacitance, the pad ring 1 and the RX pad 6 form a fixed plate, and the metal dome 2 serves as a deformable plate.

It is to be understood that the pad ring 1, the metal dome 2, and the connecting ribs 32 form the conductor; and if the pad ring 1 is soldered onto the TX pad 7 of the pressure-sensitive touchpad 4, the whole capacitive pressure sensor forms a complete capacitive detection channel with a corresponding detection channel of the TX pad 7. Once a force is applied to the touchpad or the metal dome 2, the metal dome 2 will move toward the RX pad 6 to cause deformation in the deformable structure, thus reducing the spacing between the formed parallel plates. Therefore, the change in capacitance can be computed based on the deformation, and then the amplitude of the pressure can be inferred by detecting the change in capacitance, thereby achieving the capacitive pressure detection function. If the applied force disappears, the deformable structure can restore to an original state.

It is to be understood that the pressure-sensitive touchpad 4 can also be a PCB, an FPC, etc. Further, the connecting part 3 includes the hollow structures 31 and the connecting ribs 32, such as four hollow structures 31 and four connecting ribs 32, and the hollow structures 31 and the connecting ribs 32 are arranged at intervals in sequence, and therefore, the resistance between the fixed surface (pad ring) and the deformable surface (metal dome 2) can be reduced, and the pressing stroke is expanded. It is to be understood that the number of the hollow structures 31 and the number of the connecting ribs 32 are not limited to four; six, eight or ten hollow structures 31 can also be provided, and six, eight or ten connecting ribs 32 can also be provided.

In one or more embodiments, if the pad ring 1 is soldered onto the TX pad 7 of the pressure-sensitive touchpad 4, the RX pad 6 which forms the parallel-plate capacitance with the metal dome 2 on the pressure-sensitive touchpad 4 is coated with a solder mask 8. Furthermore, once the metal dome 2 is pressed toward the RX pad 6 by an external force, no short circuit occurs when it contacts the RX pad 6.

In one or more embodiments, a pressure surface of the metal dome 2 is provided with a soft silicone indenter 5. In some specific embodiments, the metal dome 2 has a diameter of 8.5 mm, and the soft silicone indenter 5 has a diameter of 5 mm, such that the metal dome 2 (deformable surface) has a larger pressed area and makes a greater stroke change easier. Further, since the soft silicone indenter 5 has elasticity, if the pressure on a back shell contact surface 51 of the soft silicone indenter 5 (for example, if this capacitive pressure sensor is applied to a pressure-sensitive touchpad of a laptop, a back shell is a structural member for mounting the pressure-sensitive touchpad, and the structural member directly contacts the soft silicone indenter) disappears, the soft silicone indenter 5 will reset, thereby driving the metal dome 2 to reset quickly.

It is to be understood that the metal dome 2 has the diameter of 8.5 mm, the soft silicone indenter 5 has the diameter of 5 mm, and the diameter of the soft silicone indenter 5 is less than that of the metal dome 2, such that the smaller force application surface serves as a “punch”, for example, if the soft silicone is treated as a user finger, the dispersed pressing force is concentrated on a very small point and then transmitted to the metal dome 2. Therefore, the deformation response speed of the metal dome 2 can be greatly increased.

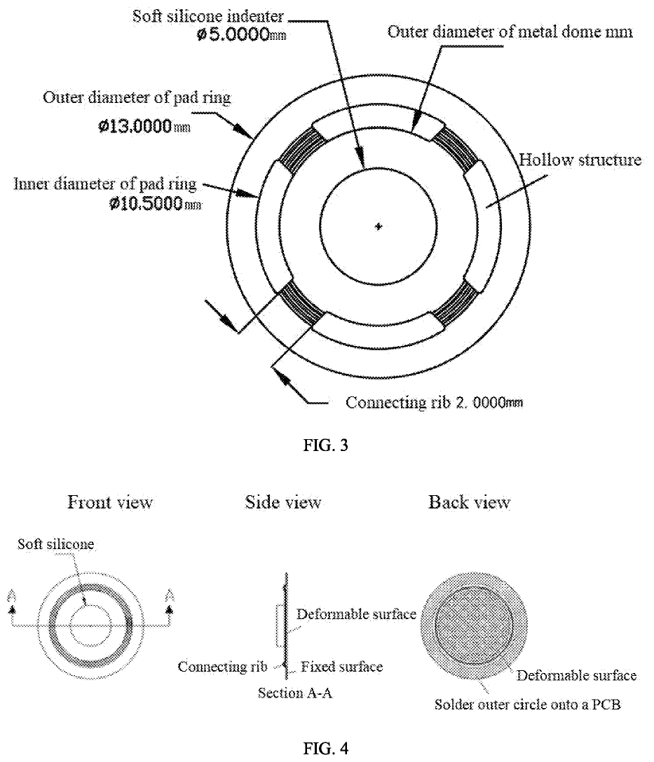

Further, as shown in FIG. 3, as a specific example, an outer circle of the capacitive pressure sensor is soldered onto the TX pad 7 of the PCB, thus the entire sensor serves as a TX channel, in which, φ of the metal dome 2 (deformable surface) is shown as φ=8.5 mm, and the RX pad 6 of the PCB is under the metal dome, an outer diameter of the pad ring is shown as φ=13 mm, and an inner diameter of the pad ring is shown as φ=10.5 mm. If a user presses any portion on the touch surface of the PCB, the soft silicone indenter 5 will compress the deformable surface of the metal dome sensor to generate a stroke, thus changing the distance to the RX pad 6. The distance D between two electrodes is changed, thereby causing the change in capacitance C. After detecting this change in capacitance, the touch chip can determine whether there is a press or the magnitude of the pressure in pressing according to the following parallel-plate capacitance formula.

Parallel-plate capacitance formula:

C=ε*S/(4*π*K*D);

in which, C: capacitance; ε: dielectric constant; S: area of two parallel plates facing each other; K: electrostatic force constant; D: distance from the deformable surface to the RX pad. In specific computation, the dielectric constant can be 1, and the electrostatic force constant is 8,900,000,000 N.

As shown in FIG. 4, as a comparison with the capacitive pressure sensor in this embodiment, another capacitive pressure sensor structure is provided, and this structure is different from the capacitive pressure sensor in this embodiment in that: the fixed surface and the deformable surface are connected by a continuous circle of connecting ribs, the hollow structures are provided, and other aspects are consistent with the capacitive pressure sensor in this embodiment.

If a force of 100 g is applied to the capacitive pressure sensor in this embodiment, the stroke of the deformable surface changes by about 0.04 mm, and the distance from the deformable surface of the metal dome sensor to the RX pad remains 0.11. For convenience of computation, S is a square with a length of 7.53 mm and a width of 7.53 mm. After substituting into the above parallel-plate capacitance formula, a capacitance of 4.61 pF is obtained, and the capacitance of 3.38 pF before deformation is subtracted from the capacitance of 4.61 pF to obtain a variation of 1.23 pF.

If a force of 100 g is applied to the comparative pressure sensor structure used for comparison by the soft silicone indenter with a diameter of 5 mm, the stroke of the deformable surface changes by about 0.01 mm, and the distance from the deformable surface of the metal dome sensor to the RX pad remains 0.14. For convenience of computation, S is a square with a length of 7.53 mm and a width of 7.53 mm. After substituting into the above parallel-plate capacitance formula, a capacitance of 3.62 pF is obtained, and the capacitance of 3.38 pF before deformation is subtracted from the capacitance of 3.62 pF to obtain a variation of 0.24 pF.

Therefore, the capacitive pressure sensor in this embodiment can significantly increase the capacitance variation, and thus the problems of poor consistency and linearity in existing capacitive pressure sensors can be solved well.

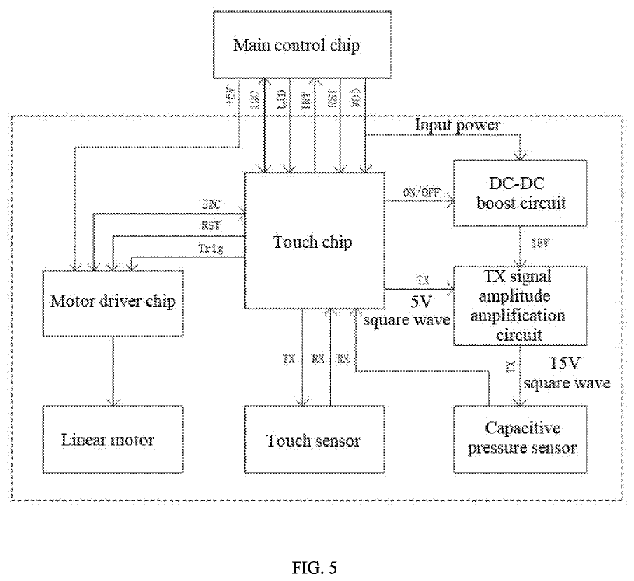

Embodiment 2: As shown in FIG. 5, based on the same inventive concept, this embodiment provides an apparatus for improving pressure detection precision of a capacitive pressure-sensitive touchpad; the apparatus includes the capacitive pressure sensor described in the Embodiment 1 and further includes a touch chip, a DC-DC boost circuit, and a TX signal amplitude amplification circuit. The touch chip is connected to both the DC-DC boost circuit and the TX signal amplitude amplification circuit, and the DC-DC boost circuit is connected to the TX signal amplitude amplification circuit; a TX pad soldered to a pad ring is arranged on the back of the pressure-sensitive touchpad, and the TX signal amplitude amplification circuit connects the TX pad with the pad ring; and an RX pad is arranged on the back of the pressure-sensitive touchpad and is connected to the touch chip.

In this present invention, the DC-DC boost circuit and the TX signal amplitude amplification circuit are utilized to raise a TX drive voltage in normal voltage processes of the touch chip to be above 15 V, and up to 20 V; a high-amplitude drive voltage can be utilized to detect slight pressure deformation on the capacitive pressure-sensitive touchpad; and in combination with the capacitive pressure sensor that can significantly increase the capacitance variation in the Embodiment 1, the sensitivity, consistency, and linearity in the pressure detection for the capacitive pressure-sensitive touchpad can be effectively improved.

In one or more embodiments, it further includes a main control chip, a motor driver chip, and a linear motor connected to the motor driver chip. Specifically, the main control chip is connected to the touch chip and the DC-DC boost circuit, and the motor driver chip is connected to the touch chip and the main control chip.

It is to be understood that by means of the motor design, the user can experience pressure feedback, thus enhancing the pressure touch experience for products such as laptops, smartphones, and wearable devices.

Based on the above embodiments, the main control chip can provide an operating power supply VDD (Voltage Drain-Drain) for the touch chip, the DC-DC boost circuit, and the motor driver chip. On the premise of providing the operating power supply VDD, the touch chip sends a start signal to the DC-DC boost circuit and sends a TX signal to the TX signal amplification circuit; the DC-DC boost circuit boosts the input voltage provided by the main control chip to reach a set value according to the obtained start signal; after receiving the boosting voltage, the voltage of the TX signal is amplified to a preset amplitude by the TX signal amplification circuit, the amplified TX signal serves as a drive signal for the capacitive pressure sensor; the touch chip acquires the RX signal sensed by the capacitive pressure sensor in real time when the front surface of the pressure-sensitive touchpad experiences pressure, and computes the corresponding magnitude and position of the pressure through an algorithm based on the acquired RX signal, and finally, transmits the computed pressure magnitude and position to the main control chip for next processing.

It is to be understood that, besides the pressure detection function, the capacitive pressure-sensitive touchpad also has a touch detection function, and a touch signal on the front surface of the capacitive pressure-sensitive touchpad can be acquired through the touch sensor that is connected to the touch chip. It can be performed in the prior art and will not be listed here.

Further, the main control chip can be configured according to different products; if this apparatus is used for pressure and touch detection on the laptop, the main control chip is a computer-end main control chip; and if this apparatus is used for pressure and touch detection on the wearable device, the main control chip is the main control chip of the wearable device.

It is also be understood that the touch chip is a mutual-capacitance touch chip, and mutual-capacitance detection output data of the mutual-capacitance touch chip is mainly related to the drive voltage of the TX signal, an internal computation amplification factor of the chip, and the variation of the capacitance to be tested, that is;

$${V}_{o} = - \frac{{C}_{m}}{{C}_{f}} * {V}_{i} ,$$

in which, V0 refers to a test output voltage signal of a capacitance to be tested, Vi refers to the drive voltage of the TX signal, Cm refers to the capacitance to be tested, and Cf refers to an internal feedback capacitance of the chip.

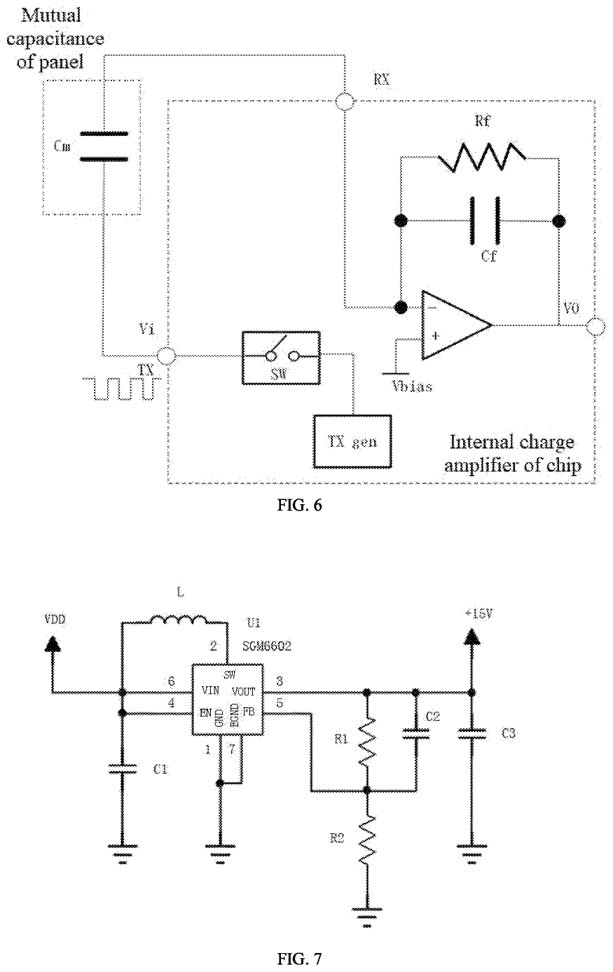

As shown in FIG. 6, according to the above formula, it can be seen that it is needed to change in two aspects to improve the mutual-capacitance detection output data of the touch chip: 1, it is needed to increase the drive voltage Vi of the TX; and 2, it is needed to increase the variation of the capacitance Cm to be tested; Cf refers to the internal feedback capacitance of the chip, and it defines the amplification factor of the operational amplifier; and after the chip is determined, the maximum value of this parameter is fixed. Currently, due to chip process and cost factors, the maximum TX drive voltage of the touch chip of the touchpad is generally about 12 V, and for some chips, it is only about 6 V. Therefore, in order to increase the TX drive voltage, the boost circuit and the TX amplitude amplification circuit can be added in a peripheral circuit of the touch chip to raise the TX drive voltage to be over 15 V. It is to be noted that in FIG. 6, TXgen refers to a signal generator which is configured to generate a square wave with a specific frequency (such as 200 KHz) in this embodiment, and it is the TX signal as described above.

As shown in FIG. 7, in one or more embodiments, the DC-DC boost circuit is configured to raise the supplied input voltage to the set value and then to output the input voltage to the TX signal amplitude amplification circuit, and the input voltage is provided by the main control chip. The DC-DC boost circuit includes a boost converter U1, a first resistor R1, a second resistor R2, a first capacitor C1, a second capacitor C2, a third capacitor C3, and an inductor L. A pin 6 of the boost converter U1 is supplied with the input voltage; a pin 2 is connected to the pin 6 and a pin 4 through the inductor L; the pin 2, the pin 4, and the pin 6 are grounded through the first capacitor C1; the first resistor R1 and the second resistor R2 are connected in series; a pin 5 of the boost converter U1 is connected between the resistor R1 and the resistor R2, in which, the resistor R1 and the resistor R2 are connected in series; one end of the resistor R1 is connected to the pin 3 of the boost converter U1, and one end of the resistor R2 is grounded; one plate of the second capacitor C2 is connected between the resistor R1 and the resistor R2, in which, the resistor R1 and the resistor R2 are connected in series, and the other plate is connected to the pin 3 of the boost converter U1; one plate of the third capacitor C3 is connected to the pin 3 of the boost converter U1, and the other plate is grounded; and the pin 3 of the boost converter U1 is the output terminal of the DC-DC boost circuit and is configured to output the voltage that is boosted to the set value.

Based on the above embodiment, the boost converter U1 can be SGM6602 from SGMICRO, and has the maximum voltage up to 20 V, that is, the above set value is not less than 15V and not greater than 20 V. Different resistances can be selected for the first resistor R1 and the second resistor R2 to set to output the optimal voltage.

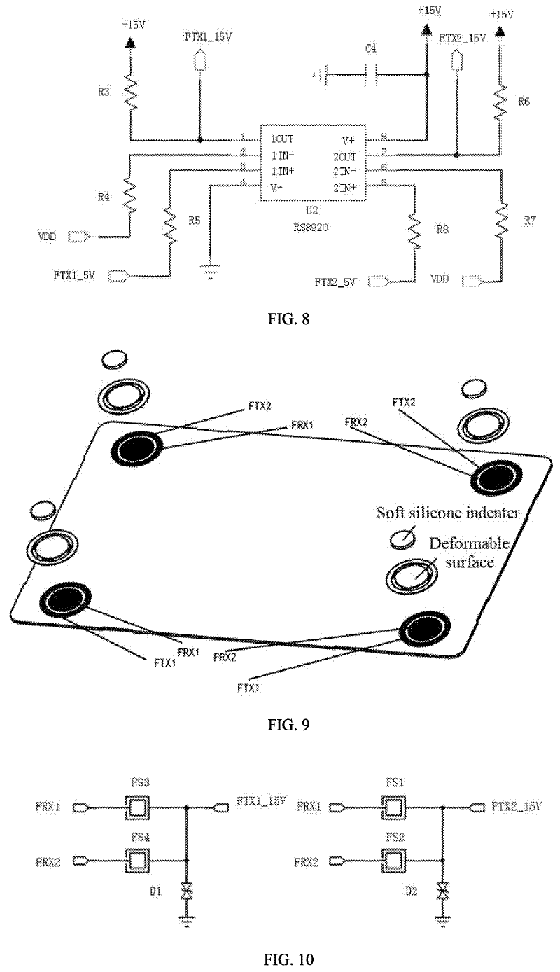

As shown in FIG. 8, in one or more embodiments, the TX signal amplitude amplification circuit amplifies the voltage amplitude of the inputted TX signal to a preset amplitude and then outputs to the TX pad, and the inputted TX signal is provided by the touch chip. The TX signal amplitude amplification circuit includes a comparator U2, a third resistor R3, a fourth resistor R4, a fifth resistor R5, a sixth resistor R6, a seventh resistor R7, an eighth resistor R8, and a fourth capacitor C4. The pin 1 and a pin 7 of the comparator U2 are the two output terminals of the TX signal amplitude amplification circuit; the pin 1 is pulled up to 15V through the third resistor R3, and the pin 7 is pulled up to 15V through the sixth resistor R6; the pin 2 of the comparator U2 is connected to the reference voltage VDD through the fourth resistor R4, and the pin 6 of the comparator U2 is connected to the reference voltage VDD through the seventh resistor R7; the pin 3 and the pin 5 of the comparator U2 are connected to the input TX signal through the fifth resistor R5 and the eighth resistor R8, respectively; the pin 8 of the comparator U2 is connected to the output terminal of the DC-DC boost circuit and grounded through the fourth capacitor C4; and the TX signal is a 5V square wave signal, and the reference voltage VDD is a 3.3V voltage signal. It is to be noted that the third resistor R3 and sixth resistor R6 are pull-up resistors.

Based on the above embodiment, the comparator U2 can be RS8920 with high-speed and high-voltage performance and is capable of amplifying the 5V coded square wave signal of a TX channel to 15V (preset amplitude), and the maximum amplitude is up to 20 V.

Based on the above embodiments, for the TX signal and the RX signal used in pressure detection, conventional touch channel pins of the touch chip can be selected on the premise of facilitating the wiring of the capacitive pressure-sensitive touchpad, and conventional voltage process is selected for the touch chip, such that the cost is relatively low; in addition, four or six capacitive pressure sensors can be selected according to the size of the touchpad; if four capacitive pressure sensors are selected, two TX signals and two RX signals are utilized; and if six capacitive pressure sensors are selected, three TX signals and three RX signals are utilized.

In one or more embodiments, the TX signal sent by the touch chip to the TX signal amplitude amplification circuit is a square wave signal with a voltage of 5V and a frequency of 100 KHz-200 KHz. The TX signal generated by the TX signal amplitude amplification circuit is a square wave signal with a voltage of 15V and a frequency of 100 KHz-200 KHz.

Based on the above embodiments, the TX signal frequency is set to be 100 KHz-200 KHz; the signal delay generated by the comparator does not affect the reception of the RX signal by the touch chip because one signal period of 200 KHz is 5 us (high level: 2.5 us, low level: 2.5 us), and the delay time of the RS8920 comparator is within 100 ns, and in combination with the delay of a load circuit, the total delay is less than 1 us; and the RX detection of the touch chip is generally set near a front end of a falling edge of the TX square wave signal, so the comparator delay does not affect the RX signal detection.

In one or more embodiments, once the pad ring of the capacitive pressure sensor is connected to the TX signal amplitude amplification circuit, it also enhances electrostatic protection through a TVS diode D.

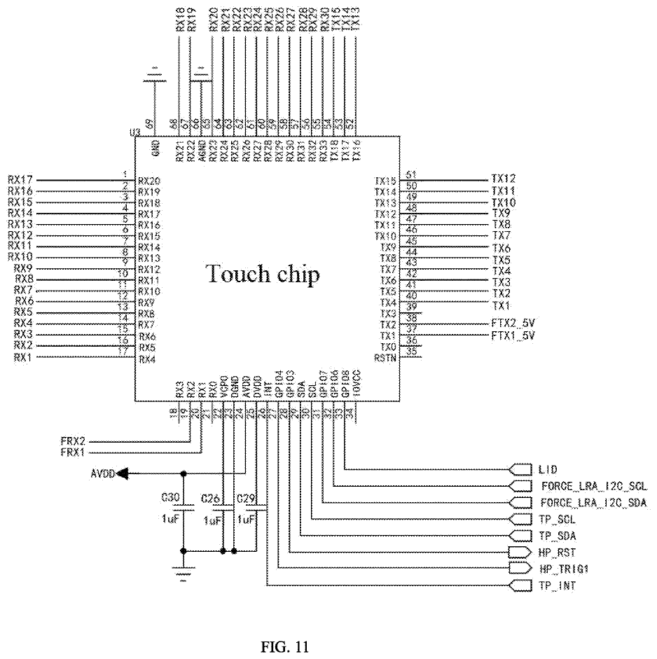

As shown in FIG. 9 to FIG. 11, as a specific embodiment, four capacitive pressure sensors are arranged on the pressure-sensitive touchpad, namely, FS1-FS4; the four capacitive pressure sensors are respectively placed at four corners of the pressure-sensitive touchpad. The corresponding RX pads of the sensor FS1 and the sensor FS3 correspond to a common port FRX1, while the corresponding RX pads of the sensor FS2 and the sensor FS4 correspond to a common port FRX2; the corresponding TX pads of the sensor FS1 and the sensor FS2 correspond to a common port FTX2, while the corresponding TX pads of the sensor FS3 and the sensor FS4 correspond to a common port FTX1. A pin 19 and a pin 20 of the touch control chip are connected to the common port FRX2 and the common port FRX1 of the capacitive pressure sensor, respectively; and a pin 37 and a pin 38 are connected to the input terminal (the pin 3 of the comparator U2) corresponding to the pin 3 and the input terminal (the pin 5 of the comparator U2) corresponding to the pin 5 of the TX signal amplitude amplification circuit. The output terminal (the pin 1 of the comparator U2) corresponding to the pin 1 of the TX signal amplitude amplification circuit is connected to the common port FTX1, and the common port FTX1 enhances the electrostatic protection through a TVS diode D1; and the output terminal (the pin 7 of the comparator U2) corresponding to the pin 7 is connected to the common port FTX2, and the common port FTX1 enhances the electrostatic protection through a TVS diode D2.

The above are only the preferred embodiments of the present invention. Those skilled in the art will understand that various changes or equivalent replacements can be made to these features and embodiments without departing from the spirit and scope of the present invention. In addition, under the guidance of the present invention, these features and embodiments can be modified to adapt to specific situations and materials without departing from the spirit and scope of the present invention. Therefore, the present invention is not limited to the specific embodiments disclosed herein, and all embodiments falling within the scope of the claims of this application are within the protection scope of the present invention.

What is claimed is:

1. An apparatus for improving pressure detection precision of a capacitive pressure-sensitive touchpad, comprising a capacitive pressure sensor, a touch chip, a DC-DC boost circuit, and a TX signal amplitude amplification circuit, wherein
the touch chip is connected to both the DC-DC boost circuit and the TX signal amplitude amplification circuit, and the DC-DC boost circuit is connected to the TX signal amplitude amplification circuit; a TX pad soldered to a pad ring is arranged on the back of the pressure-sensitive touchpad, and the TX signal amplitude amplification circuit connects the TX pad with the pad ring; an RX pad is arranged on the back of the pressure-sensitive touchpad and is connected to the touch chip;
the TX signal amplitude amplification circuit amplifies the voltage amplitude of an inputted TX signal to a preset amplitude and then outputs to the TX pad, and the TX signal amplitude amplification circuit comprises a comparator U2, a third resistor R3, a fourth resistor R4, a fifth resistor R5, a sixth resistor R6, a seventh resistor R7, an eighth resistor R8, and a fourth capacitor C4;
a pin 1 and a pin 7 of the comparator U2 are two output terminals of the TX signal amplitude amplification circuit; the pin 1 is pulled up to 15V through the third resistor R3, and the pin 7 is pulled up to 15V through the sixth resistor R6; a pin 2 of the comparator U2 is connected to a reference voltage VDD through the fourth resistor R4; and a pin 6 of the comparator U2 is connected to the reference voltage VDD through the seventh resistor R7; a pin 3 and a pin 5 of the comparator U2 are connected to the inputted TX signal through the fifth resistor R5 and the eighth resistor R8, respectively; a pin 8 of the comparator U2 is connected to the output terminal of the DC-DC boost circuit and grounded through the fourth capacitor C4; the TX signal is a 5V square wave signal; and the reference voltage VDD is a 3.3V voltage signal.

2. The apparatus for improving the pressure detection precision of the capacitive pressure-sensitive touchpad according to claim 1, wherein the DC-DC boost circuit raises a supplied input voltage to a set value and then outputs to the TX signal amplitude amplification circuit, and the DC-DC boost circuit comprises a boost converter U1, a first resistor R1, a second resistor R2, a first capacitor C1, a second capacitor C2, a third capacitor C3, and an inductor L;
the pin 6 of the boost converter U1 is supplied with the input voltage; the pin 2 is connected to the pin 6 and a pin 4 through the inductor L; the pin 2, the pin 4, and the pin 6 are grounded through the first capacitor C1; the pin 5 of the boost converter U1 is connected between the first resistor R1 and the second resistor R2, in which, the first resistor R1 and the second resistor R2 are connected in series; one end of the first resistor R1 is connected to the pin 3 of the boost converter U1, and one end of the second resistor R2 is grounded; one plate of the second capacitor C2 is connected between the first resistor R1 and the second resistor R2, in which, the first resistor R1 and the second resistor R2 are connected in series, and the other plate is connected to the pin 3 of the boost converter U1; one plate of the third capacitor C3 is connected to the pin 3 of the boost converter U1, and the other plate is grounded; and the pin 3 of the boost converter U1 is the output terminal for boosting voltage of the DC-DC boost circuit.

3. The apparatus for improving the pressure detection precision of the capacitive pressure-sensitive touchpad according to claim 1, wherein the frequency of the TX signal sent by the touch chip to the TX signal amplitude amplification circuit is 100 KHz-200 KHz, and the frequency of the TX signal amplified by the TX signal amplitude amplification circuit is 100 KHz-200 KHz.

4. The apparatus for improving the pressure detection precision of the capacitive pressure-sensitive touchpad according to claim 1, wherein once the pad ring of the capacitive pressure sensor is connected to the TX signal amplitude amplification circuit, electrostatic protection is also enhanced through a TVS diode D.

5. The apparatus for improving the pressure detection precision of the capacitive pressure-sensitive touchpad according to claim 1, further comprising a main control chip which is connected to the touch chip and the DC-DC boost circuit.

6. The apparatus for improving the pressure detection precision of the capacitive pressure-sensitive touchpad according to claim 5, further comprising a motor driver chip and a linear motor connected to the motor driver chip, wherein the motor driver chip is connected to the touch chip and the main control chip.

7. The apparatus for improving the pressure detection precision of the capacitive pressure-sensitive touchpad according to claim 1, wherein the capacitive pressure sensor comprises a pad ring arranged on the periphery, a metal dome arranged in the pad ring, and a connecting part arranged between the pad ring and the metal dome; the metal dome is lifted by the connecting part from the plane of the pad ring to form a stroke with a preset height; the connecting part comprises hollow structures and connecting ribs, and the hollow structures and the connecting ribs are arranged at intervals in sequence; the connecting ribs form a deformable structure with the metal dome, and the pad ring, the metal dome, and the connecting ribs form a conductor; once the pad ring is soldered onto the TX pad of the pressure-sensitive touchpad, the metal dome and the corresponding RX pad on the pressure-sensitive touchpad form a parallel-plate capacitance; the pad ring and the RX pad form a fixed plate; and the metal dome serves as a deformable plate.

8. The apparatus for improving the pressure detection precision of the capacitive pressure-sensitive touchpad according to claim 7, wherein once the pad ring is soldered onto the TX pad of the pressure-sensitive touchpad, the RX pad which forms the parallel-plate capacitance with the metal dome on the pressure-sensitive touchpad is coated with solder mask.

9. The apparatus for improving the pressure detection precision of the capacitive pressure-sensitive touchpad according to claim 7, wherein a pressure surface of the metal dome is provided with a soft silicone indenter.
